(19) United States
(12) Patent Application Publication
(10) Pub. No.: US 2009/0259536 A1
(43) Pub. Date: Oct. 15, 2009

(54) Method and System for Distributed Electronic Media Advertising in the Internet

(76) Inventors: Yehuda Yatskan, Jerusalem (IL); Dror Ben Yehuds, Jerusalem (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/102,064

(22) Filed: Apr. 14, 2008

(51) Int. Cl. G06Q 30/00

(52) U.S. Cl. 705/14

(57) ABSTRACT

A system and a business method for a dynamic, widespread and far-reaching advertising in the internet. A system wherein advertisements, can be pasted by end users in a variety of electronic media.

End users enter a Web site in the net or use a dedicated software installed on their station, choose advertisement they like, and paste it onto various destinations in electronic media as for example e-mails, blogs, forums, and personal web sites. Friends or other people entering those sites, blogs forums, or e-mails, might click on the pasted advertisement for viewing further information. Each advertisement is monitored and benefit to the advertiser and end users, is directly proportional with the number of per click on each pasted advertisement.

### FIELD OF THE INVENTION

This invention is in the field of advertising in the internet, and in particular a business method to exponentially spread advertising, with a built in incentive to encourage the persons involved to spread the advertisements to a maximum exposure.

### BACKGROUND OF THE INVENTION

The internet is significant and efficient means for reaching a wide number of people, and that is why there is a huge potential for advertising on the internet.

The prior art shows that there are many ways to advertise in the internet, but common to all the ways is that, although the advertisement can be changed, by flashes, pop ups, or loops, the advertisement is fixed in the sense that the advertisement is not transferred to other electronic media, and can only be seen in the place the advertisement is initially placed.

A system that will enable pasting advertisements, in many different places on the Web as an email, forums, blogs and other electronic media, by different users, will increase the exposure of the advertisements to different sectors in our society. Advertisers would benefit if their advertisements were seen by wider population.

What is needed is a system with built in incentive to encourage the persons involved to spread the advertisements to a maximum exposure. Spreading advertisements to recipients who familiar with the sender increase the possibility of viewing the advertisements and not ignoring them, as common when advertisements are received from unknown sender as for example junk mails. Also when the pasted advertisement is presented as part of the contents as in forums, blogs or personal sites and not pop-up in separate window, as common for many advertisements today, is also increasing the potential of such advertisement to be read.

### SUMMARY OF THE INVENTION

It is to be understood that both the foregoing general description and the following detailed description present embodiments of the invention and are intended to provide an overview or framework for understanding the nature and character of the invention as it is claimed.

This invention reveals business method and a system that exposes advertisements to an ever widening circle of Web and e-mail users.

This distribution is effected by having media users agree to paste advertisements of advertising companies on all or portion of the uses' activities in electronic media communication and be rewarded with relation to the exposure of that advertisement.

The users are herein referred to as agents. The advertising companies are herein referred to as the client and the person making connection between client and agents is herein referred to as the organizer.

The organizer makes agreements with the client to spread the advertisement of the client to agents. Agents making agreements with the organizer to paste advertisements of the client in different electronic media like emails, blogs, forums and other personal web sites. The net users who see the pasted advertising from the agents will from time to time click on the advertisements to see more details.

Each advertisement is coded with the identity of the agent who pastes the advertisement, monitored by the organizer and each click is counted. The client pays the organizer with relation to the number of clicks, and the organizer further pays the agent per click of the advertisements pasted by the agent on electronic media of others. The agent has thereby an incentive to spread and paste the advertisement of the client as much as possible.

Also when an advertisement has been pasted onto a recipient media, for example in an email, and that recipient send a copy of that advertisement on a forward action or by copy paste and the 3^{rd} or 4^{th} party received the advertisement and click on the advertisement, then the original agent will be credited with the clicks on the advertisement by the 3^{rd} and 4^{th} parties.

Client may also be an agent. When agent identify to the organizer as belongs or part of the client, he will be allowed to view and chose advertisements only from the advertisements of that client, and will not be able to paste advertisements from other clients.

Advertisements are dynamic and changeable also in a way that, the organizer who monitors the advertisements has control on the content of all the advertisements, and at the request of the client, as for example when campaign is changed, the organizer can change the advertisements content in each place that the advertisements had been pasted, by any agent. Click on such changed advertisement still credits the agent who pasted that advertisement.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only

FIG. 1 is a block diagram of the relationship between, the client, the organizer and the agents, in this method and system for distributed advertising in the internet.

FIG. 2 is a block diagram illustrating the steps of the method and system for distributing advertising in the internet.

FIG. 3 is a block diagram that shows the system of payments.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

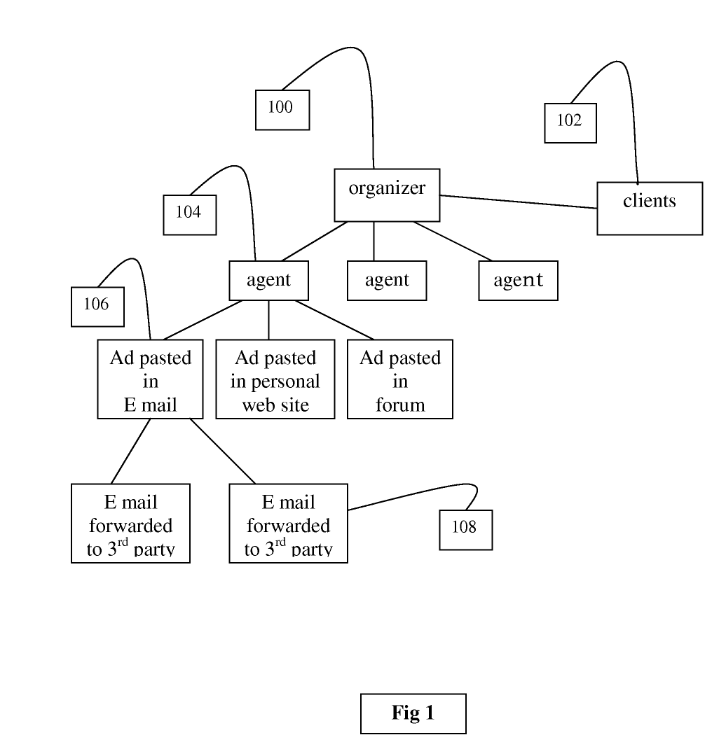

FIG. 1 shows the main parties involved in this method and system for advertising in the internet, and the relation between those parties. The organizer 100 makes agreements with clients 102 who wish to advertise.

The organizer 100 could produce the advertisement according to the specifications of the client, and manage the advertising campaign. Alternatively, the production could be done by a third party, and the organizer will only manage the advertising campaign.

The organizer 100 is the intermediary between the client 102 and the agent 104. End users who wish to act as an agent would be able to do so by visit the internet site managed by the organizer 100 and follow the instruction of the organizer.

The agents 104 would be able to choose from a selection of advertisements represented to him by the organizer 100. The agent 104 would then paste the selected advertisement onto different and various destinations in the internet, as for example e-mails, blogs, forums, and his personal web sites. Pasted advertisements might be forwarded to 3^{rd} or 4^{th} parties for example by e-mail, when the receiver 106 of an email with an advertisement pasted by the agent 104, sends that email to a further recipient 108 then the further recipient 108 would also be able to view the pasted advertisement.

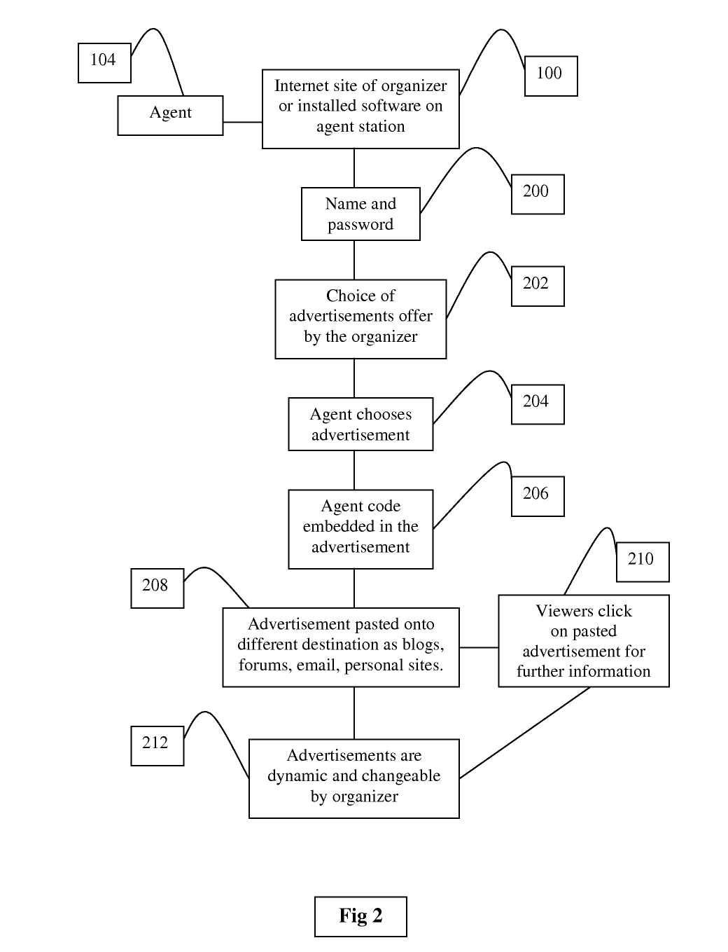

FIG. 2 shows the steps involved in this method and system for advertising in the internet.

The agent 104 enters the system of distributed advertising by visiting the internet site of the organizer 100, entering his name and password 200, or registering as a new agent and receiving a new password. Alternatively the agent might enter the system of distributed advertising directly by using dedicated software that had been downloaded and installed on the agent station.

The agent then received a variety of advertisements 202 which are offered by the organizer 100 to be chosen by agent 104. The selection of the advertisements 202 might be of different clients or might be different advertisements of same client. If the agent is for example employee of the client, the organizer might offer him to view and chose advertisements only from the advertisements belong to that client, and the agent will not be able to choose advertisements from other clients, depending on the agreement between the organizer and the client.

The agent chooses 204 the advertisement he feels will be attractive for his recipients to open. The chosen advertisement is embedded with the agent personal code 206. The agent is then able to paste 208 the selected advertisement onto different and various destinations in the internet, as for example e-mails, blogs, forums, and his personal web sites.

After the advertisement is pasted 208 on different places through the Web, any person 210 who sees that advertisement is able to click on that advertisement to view further information or directly linked to the client web site. Each advertisement is monitored by the organizer and every click is registered and counted.

The pasted advertisements are dynamic 212 and changeable in a way that, the organizer who monitors the advertisements has also control on the contents of all pasted advertisements, and at the request of the client, as for example when campaign is changed, the organizer can change the advertisements content in each place that the advertisements had been pasted, by any agent, and still connected to the internet. Click on such changed advertisement still credits the agent who pasted that advertisement.

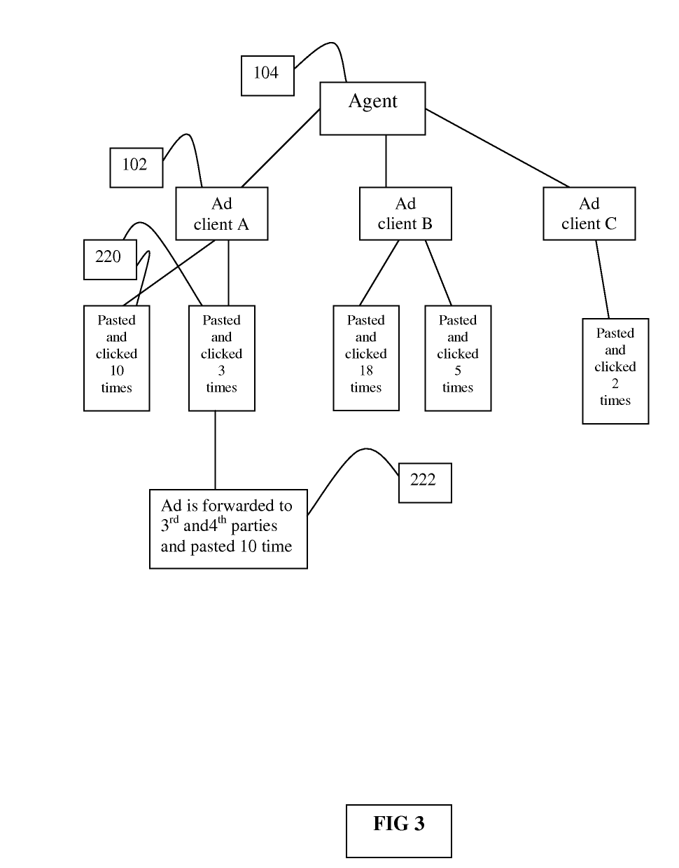

FIG. 3 explains the system of payments in this method and system for advertising in the internet.

The main object in this system is to crate a built in incentive to encourage the persons involved to spread the advertisements to a maximum exposure. Payment for advertising is related to the exposure of the advertisement. Agent 104 chooses advertisement of client A 102 and pastes it in different location through the net. Any person who wants to view further information on the advertisement clicks on the advertisement. Each advertisement is embedded with the agent code, and monitored by the organizer. Every click on the advertisement is registered and counted by the organizer 220. Payment is according to the number of clicks on each advertisement. The organizer pays the agent per click of the advertisements pasted by the agent 220. And the client pays the organizer for managing the advertisement campaign and also with regard to the number of clicks on the advertisements.

Pasted advertisement might be forwarded to 3^{rd} and 4^{th} the attached pasted advertisement. When the 3^{rd} or 4^{th} party clicks to further view the pasted advertisement, such click is also registered and counted 222 and the original agent is credited.

What is claimed:

1. A method for distributed electronic media advertising in the internet by using end users as agents, with a built in incentive, for distributing advertisements of advertisement companies (the advertisement companies herein referred to as the clients), by an organizer acting as intermediary between the client and the agent. The method comprising the following steps:
a. an agent enters the internet and into the distributed advertising system, said system including at least one of the following:
i. a server, wherein said server is hosting a website loaded with dedicated software.
ii. a server, wherein said server is loaded with dedicated software that said agent downloaded and installed at said agent's station.
b. said agent enters his name and password,
c. said agent chooses advertisement from advertisements offered by said organizer, said advertisements including text or graphic or both text and graphic.
d. said advertisement embedded with a personal code belongs to said agent,
e. said agent pastes advertisement in different electronic media such as e-mails, blogs, forums, and personal web sites,
f. clicks on said advertisement to view further information on said advertisement are registered by said organizer and counted.
g. said agent is being paid with relation to the numbers of said clicks on said advertisement.

2. A method for distributed electronic media advertising as claimed in claim 1 wherein said organizer is asked by said client to produce the advertisement according to the specifications of said client, and manage the advertising campaign.

3. A method for distributed electronic media advertising as claimed in claim 1 wherein said organizer is asked by said client only to manage the advertising campaign, and the production of said advertisement could be done by a third party.

4. A method for distributed electronic media advertising as claimed in claim 1 wherein said organizer is being paid by the clients with relation to the numbers of said clicks on advertisement pasted by said agent.

5. A method for distributed electronic media advertising as claimed in claim 1 wherein said client may be an agent. When said agent is ascribed with said client then said organizer would offer to said agent to view and chose advertisements only from advertisements belong to said client, and said agent will not be able to choose and paste advertisements from other clients.

6. A method for distributed electronic media advertising as claimed in claim 1 wherein advertisement is dynamic in the way that said organizer who monitors the advertisements has control on the content of all the advertisements, and can change the advertisement content in all places that said advertisement had been pasted, by any agent, as long as it connected to the net. Clicks on said dynamic advertisements also counted and said agent still credited.

7. A method for distributed electronic media advertising as claimed in claim 1 wherein further comprising the following steps
a. said clicks on said advertisement to view further information on said advertisement open a window with a form to be filled or with a direct link to the client web site.
b. said person who clicks said advertisement performs at least one of the following action:
i. fills said form
ii. enters said client web site
iii. purchase something from said client.
c. said agent who pasted said advertisement is being paid with relation to said action.
